(19) United States
(12) Patent Application Publication
(10) Pub. No.: US 2004/0199764 A1
(43) Pub. Date: Oct. 7, 2004

(54) Method for authentication of a user on access to a software-based system by means of an access medium

(76) Inventors: Christian Koechling, Braunschweig (DE); Thomas May, Wolfenbuettel (DE)

Correspondence Address: KENYON & KENYON, ONE BROADWAY, NEW YORK, NY, 10004, US

(21) Appl. No.: 10/474,286

(22) PCT Filed: Mar. 30, 2002
(86) PCT No.: PCT/DE02/01167

(30) Foreign Application Priority Data
Apr. 12, 2001 (DE) 101 18 267.8

(51) Int. Cl. H04L 9/00

(52) U.S. Cl. 713/155

(57) ABSTRACT

A method of authenticating a user for access to a software-based system via an access medium is described for simpler and faster authentication of a user. The user transmits his/her public key to the software-based system; the software-based system verifies whether the user has already been registered based on this key. If this is the case, the software-based system transmits to the user a string encoded using the first public key, which the user decodes using his/her private key and encodes using a key of the service server and subsequently transmits back to the service server. If the string transmitted is identical to the string received, the software-based system recognizes the user as being authenticated.

### FIELD OF THE INVENTION

The present invention is directed to a method of authenticating a user for access to a software-based system.

### BACKGROUND INFORMATION

It is known that communication between two parties via an accessible communication channel, if the communication is to be protected, may be implemented by using public and private keys. The public key is used for encoding, while the private key is used for decoding. Each party thus has a public key and a private key corresponding to it, and the public keys may then be exchanged for communication. This method is used mainly in software-based systems.

D. Patiyoot, S. J. Shepherd: “Authentication Protocols for Wireless ATM Networks” 1998 1st IEEE International Conference on ATM. ICATM'98. Conference Proceedings. Colmar, France, Jun. 22-24, 1998, IEEE, IEEE International Conference on ATM, New York, N.Y.: IEEE, U.S., Jun. 22, 1998, pp. 87-96, XP010290990 ISBN: 0-7803-4982-2 discloses the authentication of a user for access to a software-based system, in which a second public key is used in addition to a first public key.

### SUMMARY OF THE INVENTION

The method according to the present invention of authenticating a user for access to a software-based system via an access system, having the features of the independent patent claim, has the advantage over the related art that the authentication is used for access to software-based systems, which are also referred to in the following as service servers. The following advantages are implemented: the user simply dials the service and does not need to enter a password or PIN (Personal Identification Number). No secure communication is required, i.e., it is not necessary to ensure that the connection cannot be eavesdropped. This is important in particular in the case of wireless access, via Bluetooth, for example. In this way no modifications need to be made in standards such as Bluetooth. The method according to the present invention furthermore makes it possible to encrypt communication with the service, so that personal data cannot be eavesdropped on. The service server may delegate the task of determining the identity of the user and the related data storage to a central system, i.e., a registration server, which may be accessed by different service servers, for example, which are independent of one another. Users thus do not need to identify themselves using a new identifier with each service, but may use the same identifier for different services. In any further communication with the user the service server itself may ensure that it always communicates with the same user. Any registration server used is no longer involved in the further communication.

It is particularly advantageous that the Internet is used as the access medium, which makes it possible to obtain secure access to a service offered on the Internet using an electronic hand-held device, for example. Such services include banking services or shopping on the Internet which require a payment procedure, via a credit card, for example. The electronic hand-held device may advantageously be a mobile phone, a personal digital assistant, a smart phone, or a remote control. The electronic hand-held device is also referred to hereinafter as a terminal. The service server may be a control unit in a motor vehicle, for example, an ABS control unit or an ESP control unit, a vehicle's on-board computer, a car radio, a navigation system, a gateway module in a vehicle, which is connected via any bus system, for example, CAN, MOST, or IEEE1394, or a central navigation system located at a service provider outside the motor vehicle. The on-board computer in a vehicle may also be used as a terminal for selecting a software-based system via the connection via a service server in this case.

The access medium may advantageously be implemented, at least in part, as a wireless link, for example, via Bluetooth or an infrared transmission link.

It is furthermore advantageous that a registration server, which is connectable to the service server and checks whether or not the user's public key is already registered, is used.

By using a chip card, users may carry their encrypting information on the chip card independently of the terminal and then use stationary terminals which are generally accessible.

### BRIEF DESCRIPTION OF THE DRAWINGS

FIG. 1 shows a block diagram of the device according to the present invention.

FIG. 2 shows a flow chart of the method according to the present invention.

### DETAILED DESCRIPTION

Users who receive services offered by software-based systems, i.e., via service servers, need an authentication procedure for using these services. The users themselves then have a software-based system, i.e., a terminal, available for accessing the service, which provides the direct communication with the service. Examples of such terminals include a cell phone or a computer having access to the Internet, the computer being either only accessible to the user and/or being equipped with a chip card reading device or the like. The personal access data may then be stored on this chip card.

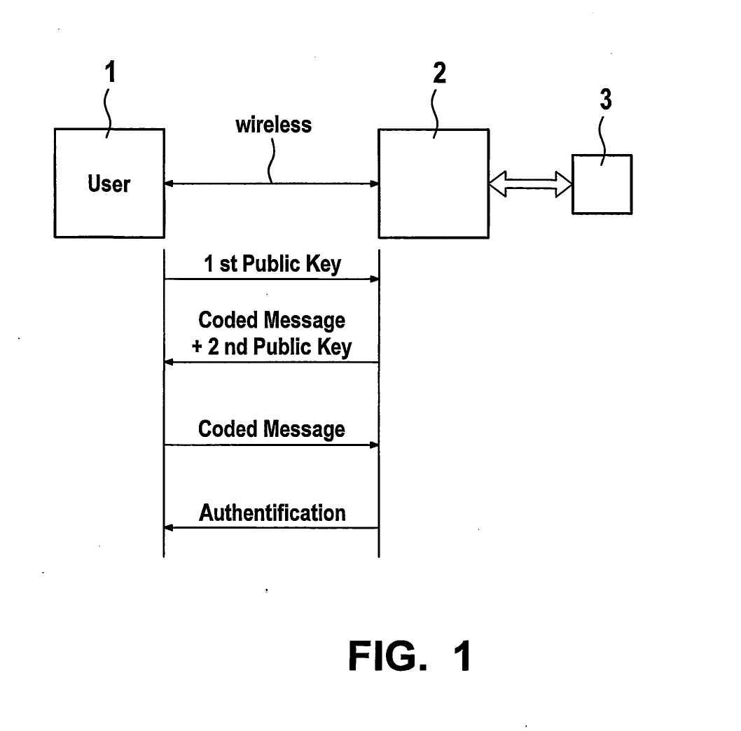

FIG. 1 illustrates the device according to the present invention as a block diagram. A user terminal 1, labeled as User, has input devices and display devices, which are not illustrated here, using which a user selects services to be subsequently used. This user terminal 1 is connected here to a service server 2 via a wireless link, labeled Wireless. Service server 2 is connected to a registration server 3 via a second data input/output.

When the user logs in to service server 2 via terminal 1, the following messages are transmitted. Initially the user transmits via the terminal his/her first public key, labeled here as Public Key. Service server 2 transmits this public key to registration server 3, which verifies whether a user has already been registered using this public key. If this is the case, registration server 3 transmits to service server 2 that the user is already registered. If this is not the case, registration server 1 transmits an error message to service server 2, which in turn likewise transmits an error message to terminal 1. Optionally users are allowed to register themselves here via an appropriate procedure.

If the user is recognized as being registered, service server 2 transmits a string encoded using the user's public key, which is only known to service server 2, as well as a second public key, which is characteristic to service server 2, i.e., service server 2 has a second private key, using which service server 2 is able to decode the messages encoded using the second public key. The user then decodes the string using terminal 1 and the user's private key, and then recodes it using the second public key and finally returns it to service server 2. Service server 2 then decodes the string using the second private key. If the string which was originally transmitted is identical to the one received by service server 2, the user is authenticated and the use of the service by the user via terminal 1 may begin. The encoding using the particular public keys which were used here also continues to be used to make the communication secure, in particular when it involves financial transactions.

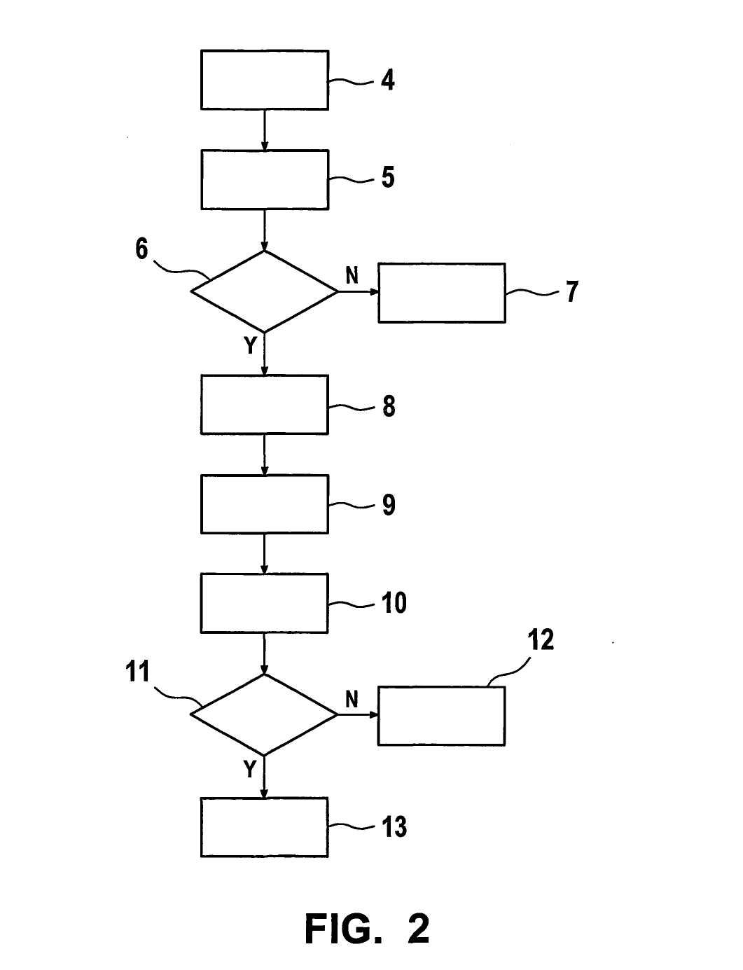

FIG. 2 shows the method according to the present invention in the form of a flow chart. In step 4 of the method, user terminal 1 transmits its public key to service server 2 via the wireless link. In step 5, registration server 3 verifies for service server 2 whether user 1 has already been registered. For this purpose, the public key is compared with a database of registration server 3. As an alternative, this verification may also be performed by service server 2 itself using an appropriate database.

In step 6, it is verified whether or not the user is registered. If this is not the case, the authentication is aborted in step 7, and this is communicated to user 1. If, however, this is the case, in step 8 service server 2 transmits to user 1 a string which is only known to service server 2, encoded with the first public key, as well as a second public key, which is characteristic to service server 2.

In step 9, user 1 decodes, using his/her private key, the encoded string and recodes it using the second public key of service server 2. The user then returns the recoded string to service server 2 again. In step 10, service server 2 decodes the string again with its private key and performs a comparison as to whether the originally transmitted string, unencoded, is identical to the decoded string. If this is the case, a decision is made in step 11 that the service may now be used in step 13, because the user is authenticated. If, however, it is determined in step 11 that the comparison does not result in the matching of the strings, the user is informed in step 12 that he/she could not be authenticated. Registration of the user may optionally follow.

If the user uses a public terminal as terminal 1, encoding and decoding, as well as storing and provision of the key may take place via a chip card, which is inserted in the terminal. Access to the software-based system may then take place via the Internet. Terminal 1 and/or service server 2 and registration server 3 then have appropriate interfaces.

The string may be generated by service server 2 using a random generator, for example. If an electronic hand-held device is used as terminal 1, a wireless link may be implemented to the access medium, for example, the Internet.

1-11. (Canceled)

12. A method for authenticating a user for access to a software-based system via an access medium, comprising:
accepting from the user a first private key and a first public key;
performing a logging operation with respect to the user into the software-based system;
upon login, transmitting the first public key to the software-based system;
causing the software-based system to verify an authorization of the user based on the first public key;
causing the software-based system to transmit a second public key and a first string encoded on the basis of the first public key to the user who is authorized;
decoding the first string by the user the first string on the basis of the first private key;
recoding the first string on the basis of the second public key to produce a second string;
transmitting the second string back to the software-based system;
decoding the second string on the basis of a second private key; and
causing the software-based system to recognize the user as authentic if the first string corresponds to the second string.

13. The method as recited in claim 12, further comprising:
encoding, on the basis of the second public key, data to be transmitted by the user to the software-based system after authentication; and
encoding data to be transmitted by the software-based system on the basis of the first public key.

14. The method as recited in claim 12, further comprising:
if the user is not recognized as authorized, communicating to the user a message indicating the non-authorized status of the user.

15. The method as recited in claim 12, wherein:
the access medium includes the Internet.

16. The method as recited in claim 12, wherein:
the access medium is at least partially implemented via a wireless link.

17. A device for authenticating a user for access to a software-based system via an access medium, comprising:
an arrangement for accepting from the user a first private key and a first public key;
an arrangement for performing a logging operation with respect to the user into the software-based system;
an arrangement for, upon login, transmitting the first public key to the software-based system;
an arrangement for causing the software-based system to verify an authorization of the user based on the first public key;
an arrangement for causing the software-based system to transmit a second public key and a first string encoded on the basis of the first public key to the user who is authorized, the user decoding the first string on the basis of the first private key;
an arrangement for recoding the first string on the basis of the second public key to produce a second string;
an arrangement for transmitting the second string back to the software-based system;
an arrangement for decoding the second string on the basis of a second private key; and
an arrangement for causing the software-based system to recognize the user as authentic if the first string corresponds to the second string, wherein:
the software-based system includes a service server,
the user has a terminal available, and
the service server and the terminal have an interface to the access medium.

18. The device as recited in claim 17, wherein:
the service server is connectable to a registration server, the registration server verifying whether the user is authorized on the basis of the first public key.

19. The device as recited in claim 17, wherein:
the terminal includes an electronic companion device.

20. The device as recited in claim 17, wherein:
the service server includes a multimedia component in a motor vehicle.

21. The device as recited in claim 17, wherein:
the service server includes a control unit in a motor vehicle.

22. The device as recited in claim 17, further comprising:
a receiving device for a chip card.
